(19) United States
(12) Patent Application Publication
(10) Pub. No.: US 2024/0224350 A1
(43) Pub. Date: Jul. 4, 2024

(54) ELECTRONIC DEVICE AND METHOD FOR E2 RETENTION IN COMMUNICATION SYSTEM

(71) Applicant: Samsung Electronics Co., Ltd., Suwon-si (KR)

(72) Inventors: Yue WANG, Staines (GB); Junhyuk SONG, Suwon-si (KR)

(21) Appl. No.: 18/607,970

(22) Filed: Mar. 18, 2024

Related U.S. Application Data
(63) Continuation of application No. PCT/KR2022/014303, filed on Sep. 23, 2022.

(30) Foreign Application Priority Data
Sep. 24, 2021 (GB) 2113670.0

(51) Int. Cl. H04W 76/10; H04W 76/20; H04W 88/12; H04W 92/12

(52) U.S. Cl. CPC H04W 76/10; H04W 76/20; H04W 88/12; H04W 92/12

(57) ABSTRACT

According to various embodiments, an E2 node comprises at least one transceiver and at least one processor operably coupled to the at least one transceiver. The at least one processor is configured to control the at least one transceiver to transmit, to a near-real time (Near-RT) radio access network (RAN) intelligent controller (RIC) via an E2 interface, a E2 setup request message including E2 retention information. The at least one processor is configured to control the at least one transceiver to receive, from the Near-RT RIC via the E2 interface, a E2 setup response message in response to the E2 setup request message including E2 retention indication.

### CROSS-REFERENCE TO RELATED APPLICATION(S)

This application is a continuation application, claiming priority under § 365(c), of an International application No. PCT/KR2022/014303, filed on Sep. 23, 2022, which is based on and claims the benefit of a Great Britain patent application number 2113670.0, filed on Sep. 24, 2021, in the Great Britain Intellectual Property Office, the disclosure of each of which is incorporated by reference herein in its entirety.

### TECHNICAL FIELD

The disclosure relates to open radio access network (Open RAN). More particularly, the disclosure relates to an electronic device and a method for E2 retention in communication system.

### BACKGROUND ART

The concept of open radio access network (Open RAN) is to enable an open and disaggregated radio access network architecture to improve network flexibility, and avoid vendor lock in. In order to encourage the development of a non-fragmented Open RAN system, the O-RAN alliance has developed the O-RAN architecture, that enables the building of the virtualised RAN on open hardware and cloud, with embedded artificial intelligence (AI) powered radio control. Initiated by the O-RAN alliance, an open radio access network (O-RAN) established by operators and equipment providers in a system that combines the 4G communication system with the 5G system, defines a new network element (NE) and interface specifications based on the existing 3GPP standard, and presents the O-RAN structure.

### DISCLOSURE

### Technical Solution

It is one aim of the present disclosure, amongst others, to provide new information elements (IEs) and methods in O-RAN to support E2 retention, such that information such as E2 Service Model (E2SM) related contexts and transaction reference information, is maintained in the event of transport network layer (TNL) failure.

A first aspect provides a method of operating a telecommunication network, comprising one or more intelligent systems in the O-RAN architecture, wherein the intelligent system retains E2 service information at TNL failure, according to information elements (IEs) via an E2 interface.

In one example, the IE comprises E2 retention IEs in an E2 SETUP message via the E2 interface.

In one example, the IE comprises “E2-retained” indication, requested by the E2 nodes via the E2 interface, by including the E2 Retention Information IE set to “E2-retained” in an E2 SETUP REQUEST message.

In one example, the method comprises an “E2-retained” indication in the aforementioned UE retention IE, accepted by Near-real time (RT) radio access network (RAN) intelligent controller (RIC) via the E2 interface, by including the E2 Retention Information IE set to “E2-retained” in the E2 SETUP RESPONSE message.

In one example, Near-RT RIC retains the existing E2SM related contexts and signaling connections at TNL failure, when “E2-retained” is enabled.

In one example, the method comprises a protocol between E2 nodes and Near-RT RIC in agreeing on retaining E2 service information at E2 SETUP.

In one example, wherein the intelligent system makes a decision of whether to retain E2 service information, according to the settings of the aforementioned IE (E2 Retention IE) and indicator (“E2-retained”).

A second aspect provides a protocol between E2 nodes and Near-RT RIC in agreeing on retaining E2 service information at E2 SETUP.

A third aspect provides a network configure to implement a method according to the first aspect.

According to various embodiments, a method performed by a E2 node, the method comprises transmitting, to a near-real time (Near-RT) radio access network (RAN) intelligent controller (RIC) via an E2 interface, a E2 setup request message including E2 retention information. The method comprises receiving, from the Near-RT RIC via the E2 interface, a E2 setup response message in response to the E2 setup request message including E2 retention indication.

According to various embodiments, a method performed by a near-real time (Near-RT) radio access network (RAN) intelligent controller (RIC). The method comprises receiving, from a E2 node via an E2 interface, a E2 setup request message including E2 retention information. The method comprises transmitting, to the E2 node via the E2 interface, a E2 setup response message in response to the E2 setup request message including E2 retention indication.

### DESCRIPTION OF THE DRAWINGS

For a better understanding of the invention, and to show how exemplary embodiments of the same may be brought into effect, reference will be made, by way of example only, to the accompanying diagrammatic Figures, in which:

FIG. 1 schematically depicts open-radio access network (O-RAN) high level Architecture.

FIG. 2 schematically depicts stream control transmission protocol (SCTP) association and connection failure.

FIG. 3 schematically depicts a protocol stack of E2 application protocol (E2AP) messages.

FIG. 4 schematically depicts UE retention information IE in E2 SETUP REQUEST AND E2 SETUP RESPONSE.

FIG. 5 schematically depicts a procedure on agreeing retaining E2 information at E2 SETUP.

FIG. 6 schematically depicts an example where ‘E2-retained’ is agreed between Near-RT RIC and E2 nodes.

FIG. 7A illustrates procedures after the failure of the SCTP connection without E2 retention.

FIG. 7B illustrates procedures after the failure of the SCTP connection with E2 retention.

FIG. 8A illustrates exemplary components of E2 node according to embodiments.

FIG. 8B illustrates exemplary components of Near-RT RIC according to embodiments.

### MODE FOR INVENTION

According to the present disclosure, there is provided a network, as set forth in the appended claims. Also provided is a method. Other features of the invention will be apparent from the dependent claims, and the description that follows.

Generally, an open radio access network (O-RAN) defines radio units (RU), digital units (DU), control units (CU)-control plane (CP), and user planes (UP) as O (O-RAN)-RU, O-DU, O-CU-CP, O-CU-UP.

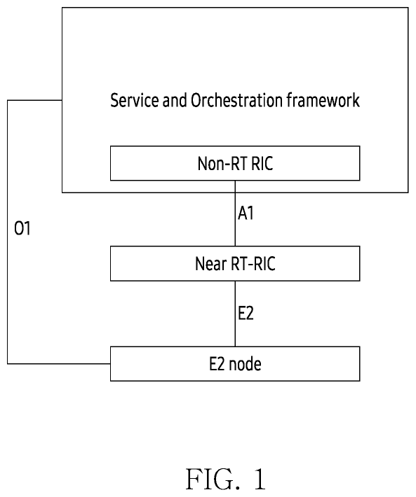

FIG. 1 describes the high-level architecture of O-RAN.

However, there remains a need to improve O-RAN.

Rando access network (RAN) intelligent controller (RIC) is a logical node that can collect information on cell sites transmitted and received by a user equipment (UE), O-eNodeB (eNB), O-DU, O-CU-CP, or O-CU-UP. The RIC can be implemented in the form of a server concentrated in one physical place or it can be implemented as a logical function within the next generation node B (gNB). In the following, the nodes that are connected to RIC through the E2 interface, are referred to as E2 nodes. It is understood that the concept presented in this invention is generally applied to E2 nodes, and the target of the invention is to present new parameters and procedures over the E2 interface, regardless of what the E2 nodes are. Here, E2 nodes may be understood as objects constituting a RAN that can operate according to the O-RAN standard, and may be referred to as an E2 node. An E2 node may also refer to an O-eNB.

The interface with the RANs that can operate according to the O-RAN standard between RIC and E2 nodes uses an application protocol (E2AP). As defined in O-RAN WG3, a given RAN Function offers a set of services to be exposed over the E2 using E2AP defined procedures. In one E2 Service Model (SM), E2SM Radio control, E2SM-RC, the E2 Node terminating the E2 Interface is assumed to host one or more instances of the RAN Function “RAN Control”.

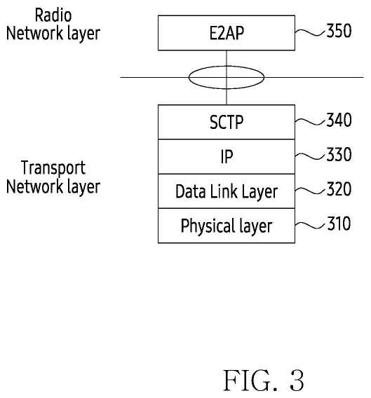

FIG. 3 shows a protocol stack of an E2 application protocol message (E2) in a wireless access network according to embodiments of the present disclosure. Referring to FIG. 3, the control plane includes a transport network layer (TNL) and a radio network layer (RNL). The transport network layer includes a physical layer 310, a data link layer 320, an internet protocol (IP) 330, a stream control transmission protocol (SCTP) 340, and the like.

The interface with the RANs that can operate according to the O-RAN standard between RIC and E2 nodes uses an E2 application protocol (E2AP). The wireless network layer includes the E2AP 350. The E2AP 350 is used to transmit a subscription message, an indication message, a control message, a service update message, and a service query message, and is transmitted from the upper layer of the SCTP 340 and the IP 330.

It is noted that when TNL fails due to the unreliable backhaul transport such as the disruption in a micro-wave link, the RNL associated information is not necessarily impacted. In the O-RAN contexts, the E2SM related contexts and transaction reference information remain consistent between the nodes and the Near-RT RIC at least until one of the nodes needs to modify a service context.

SCTP refers to the Stream Control Transmission Protocol for the purpose of transporting various signaling protocols over IP network [5]. In the O-RAN contexts, an E2 node and the Near-RT RIC supports configuration with single or multiple SCTP association between the E2 node and Near-RT RIC pair.

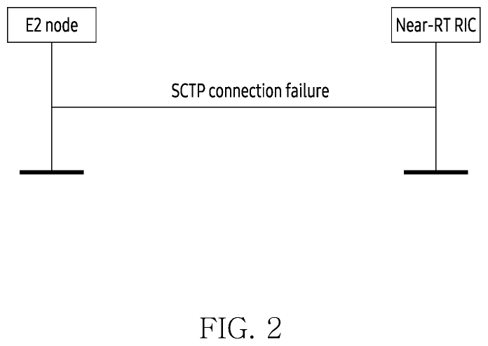

FIG. 2 illustrates a scenario with E2 Node and SCTP association and failure.

At the moment, in O-RAN standard, when the TNL is re-established after a TNL-failure, the standard mandates that all the E2 contexts, which belong to the RNL layer, are deleted. This causes the corresponding E2SM invalid. However, releasing E2 Service Context after the TNL re-establishment is not necessary. For example, when TNL is temporarily down, there may be no impact on the E2AP (i.e., RNL) association.

In TS 38.413, UE retention information is utilised to retain UE information at NG-RAN. In essence, the RNL is notified when the TNL fails. When the TNL is re-established, the RNL is notified and the RNL could make a local decision to keep the E2 Service Model contexts. It would be an advantage if service-contexts and signaling connections could be kept in cases of short SCTP failures requiring a re-establishment of the SCTP connection. This would avoid a list of service model drops at SCTP re-establishment and it would increase the reliability for the use cases that requires reliabilities.

In the following we use E2 nodes, base station, and node, exchangeably (i.e. interchangeably).

The invention relates to systems and methods for E2 Retention Support in O-RAN. The invention proposes new IEs and methods in O-RAN to support E2 retention, such that information such as E2SM related contexts and Transaction reference information, is maintained in the event of TNL failure. The benefit of having such E2 context retention includes, but not limited to:
No need to eliminate UE contexts and service information in short SCTP failures
Reduce Multiple E2s SCTP re-establishment
Voice over new radio (NR) (VoNR) and emergency call support

The first aspect provides a method of operating a telecommunication network, comprising one or more intelligent systems in the O-RAN architecture, wherein the intelligent system retains E2 service information at TNL failure, according to information elements (IEs) via an E2 interface.

In one example, the IE comprises E2 retention IEs in an E2 SETUP message via the E2 interface.

In one example, the IE comprises “E2-retained” indication, requested by the E2 nodes via the E2 interface, by including the E2 Retention Information IE set to “E2-retained” in an E2 SETUP REQUEST message.

In one example, the method comprises an “E2-retained (or described as “e2retained”, or “e2-retained”)) indication in the aforementioned UE retention IE, accepted by Near-RT RIC via the E2 interface, by including the E2 Retention Information IE set to “E2-retained” in the E2 SETUP RESPONSE message.

In one example, Near-RT RIC retains the existing E2SM related contexts and signaling connections at TNL failure, when “E2-retained” is enabled.

In one example, the method comprises a protocol between E2 nodes and Near-RT RIC in agreeing on retaining E2 service information at E2 SETUP.

In one example, wherein the intelligent system makes a decision of whether to retain E2 service information, according to the settings of the aforementioned IE (E2 Retention IE) and indicator (“E2-retained”).

The second aspect provides a protocol between E2 nodes and Near-RT RIC in agreeing on retaining E2 service information at E2 SETUP.

The third aspect provides a network configure to implement a method according to the first aspect.

The present disclosure provides new IEs and methods in O-RAN to support E2 retention, such that information such as E2SM related contexts and Transaction reference information, is maintained in the event of TNL failure.

In one example, since the E2 Setup Request shall be the first message sent on a new TNL and this message resets the interface including the E2AP contexts, the E2 Retention IE is added into E2 Setup Request/Response messages.

E2 Retention Indication is an indication that allows RNL to determine whether to preserve E2 Associate Context information when cutting TNL.

The present disclosure relates to an apparatus and method to support E2 retention, in particular, it proposes the indication of retaining E2SM contexts and service model, at TNL failure, by using a ‘E2 retention’ IE, at E2 SETUP. Here E2 Retention Indication is an indication that allows RNL to determine whether to preserve E2 Associate Context information when there is a TNL failure.

In one example, an E2 Retention Information IE is included in the E2 SETUP REQUEST and E2 SETUP RESPONSE messages. In particular, this IE allows the E2 node and the Near-RT RIC to indicate whether prior Service Model related contexts and related Service model associated logical E2-connections are intended to be retained, as follows (Table 1)

TABLE 1

| | | | | |
|---|---|---|---|---|
| | | | IE type and | Semantics |
| IE/Group Name | Presence | Range | reference | description |

| | | |
|---|---|---|
| E2 Retention | O | ENUMERATED |
| Information | | (E2-retained, . . .) |

In ‘presence’ column, the value “O” indicates ‘optional’ and a value “M” indicates ‘mandatory’.

If the E2 Retention Information IE set to “E2-retained” is included in the E2 SETUP REQUEST message, the Near-RT RIC may accept the proposal to retain the existing E2 Service Model related contexts and signaling connections by including the E2 Retention Information IE set to “E2-retained” in the E2 SETUP RESPONSE message.

In one example, the aforementioned IE contains a setting to “E2-retained”, where it allows the E2 node and the Near-RT RIC to indicate whether prior Service Model related contexts and related Service model associated logical E2-connections are intended to be retained. In particular, it is proposed that the E2 retention IE is ENUMERATED, which indicates E2 service model and contexts to be retained or not, when it is set to ‘l’ or ‘0’. In another word, if the E2 Retention function is ON (“E2-retained=1”) and the Near-RT RIC provides the E2 Interface Management function, the E2 node does not delete the UE related information in the E2 SETPUP procedure due to SCTP connection cut.

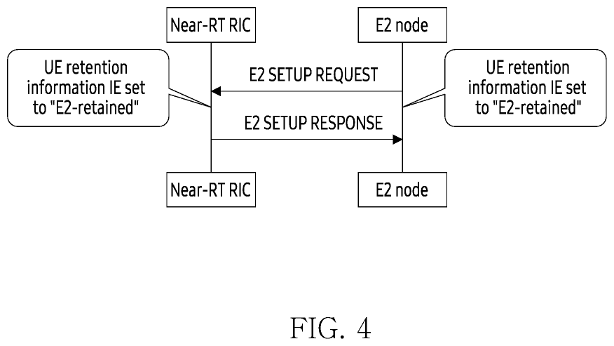

E2 SETUP procedure is to establish the signaling connection between E2 Node and Near-RT RIC. This procedure erases any existing application level configuration data in the two nodes and replaces it by the one received. This procedure also resets the E2 interface like a Reset procedure would do. This procedure is initiated by the E2 Node. The current invention proposes that, if the E2 Retention Information IE set to “E2-retained” is included in the E2 SETUP REQUEST message, the Near-RT RIC may accept the proposal to retain the existing E2SM related contexts and signaling connections by including the E2 Retention Information IE set to “E2-retained” in the E2 SETUP RESPONSE message. FIG. 4 illustrates such a protocol.

In more detail, it is proposed that this message is sent by an E2 Node to a Near-RT RIC to transfer the initialization information, as follows (Table 2).

### Direction: E2 Node→Near-RT RIC

TABLE 2

| IE/Group | | | E type and | Semantics | Criti | ssigned |
|---|---|---|---|---|---|---|
| Name | resence | Range | reference | description | cality | Criticality |
| Message Type | M | | 9.2.3 | | YES | reject |
| Transaction | M | | 9.2.33 | . | YES | reject |
| ID | | | | | | |
| Global E2 | M | | 9.2.6 | | YES | reject |
| Node ID | | | | | | |
| RAN | | 1 | . | List of RAN | YES | reject |
| Functions | | | | functions in | | |
| Added List | | | | E2 node | | |
| >RAN | | 1 . . . | | | | |
| Function item | | <maxofRANfunctionID> | | | | |
| >>RAN | M | | 9.2.8 | Id of the | — | |
| Function ID | | | | declared | | |
| | | | | Function | | |
| >>RAN | M | | 9.2.23 | Definition | — | |
| Function | | | | of Function | | |
| Definition | | | | | | |
| >>RAN | M | | 9.2.24 | Revision | — | |
| Function | | | | counter | | |
| Revision | | | | | | |
| >>RAN | M | | 9.2.31 | Object | | |
| Function OID | | | | identifier of | | |
| | | | | corresponding | | |
| | | | | E2SM | | |
| E2 Node | | 1 | | List of E2 | YES | reject |
| Component | | | | Node | | |
| Configuration | | | | component | | |
| Addition | | | | configuration | | |
| List | | | | information | | |
| >E2 Node | | 1 . . . | | | EACH | reject |
| Component | | <maxofE2nodeComponents> | | | | |
| Configuration | | | | | | |
| Addition Item | | | | | | |
| >>E2 Node | M | | 9.2.26 | E2 Node | — | |
| Component | | | | component | | |
| Interface | | | | interface | | |
| Type | | | | type | | |
| >>E2 Node | O | | 9.2.32 | E2 Node | — | |
| Component | | | | Component | | |
| ID | | | | Identifier | | |
| >>E2 Node | M | | 9.2.27 | Contents | — | |
| Component | | | | depends on | | |
| Configuration | | | | component | | |
| | | | | interface | | |
| | | | | type | | |
| E2 Retention | O | | 9.2.xx | | YES | ignore |
| Information | | | | | | |

In ‘presence’ column, the value “O” indicates ‘optional’ and a value “M” indicates ‘mandatory’.

In E2 SETUP RESPONSE, it is proposed that this message is sent by a Near-RT RIC to an E2 Node to transfer the initialization information, as follows (Table 3):

### Direction: Near-RT RIC® E2 Node

TABLE 3

| IE/Group | | | E type and | Semantics | | ssigned |
|---|---|---|---|---|---|---|
| Name | resence | Range | reference | description | Criticality | Criticality |
| Message | M | | 9.2.3 | | YES | reject |
| Type | | | | | | |
| Transaction | M | | 9.2.33 | . | YES | reject |
| ID | | | | | | |
| Global RIC | M | | 9.2.4 | | YES | reject |
| ID | | | | | | |
| RAN | | 0 . . . 1 | | Complete | | |
| Functions | | | | list of | | |
| Accepted | | | | Functions | | |
| List | | | | accepted by | | |
| | | | | Near-RT | | |
| | | | | RIC | | |
| >RAN | | 1 . . . | | | YES | Reject |
| Functions | | <maxofRANfunctionID> | | | | |
| ID item | | | | | | |
| >>RAN | M | | 9.2.8 | Id of the | — | |
| Function | | | | declared | | |
| ID | | | | Function | | |
| >>RAN | M | | 9.2.24 | Revision | — | |
| Function | | | | counter | | |
| Revision | | | | | | |
| RAN | | 0 . . . 1 | | Complete | | |
| Functions | | | | list of | | |
| Rejected | | | | Functions | | |
| List | | | | not accepted | | |
| | | | | by Near-RT | | |
| | | | | RIC | | |
| RAN | | 1 . . . | | | YES | reject |
| Functions | | <maxofRANfunctionID> | | | | |
| ID Cause | | | | | | |
| Item | | | | | | |
| >>RAN | M | | 9.2.8 | Id of the | — | |
| Function | | | | declared | | |
| ID | | | | Function | | |
| >>Cause | M | | 9.2.1 | Reason for | — | |
| | | | | not | | |
| | | | | accepting | | |
| | | | | function | | |
| E2 Node | | 1 | | Complete | YES | reject |
| Component | | | | list of E2 | | |
| | | | | Node | | |
| Configuration | | | | Components | | |
| | | | | in the E2 | | |
| Addition | | | | SETUP | | |
| Acknowledge | | | | REQUEST | | |
| List | | | | message | | |
| >E2 Node | | 1 . . . | | | EACH | reject |
| Component | | <maxofE2nodeComponents> | | | | |
| Configuration | | | | | | |
| Addition | | | | | | |
| Acknowledge | | | | | | |
| Item | | | | | | |
| >>E2 Node | M | | 9.2.26 | E2 Node | — | |
| Component | | | | component | | |
| Interface | | | | interface | | |
| Type | | | | type | | |
| >>E2 Node | M | | 9.2.32 | E2 Node | — | |
| Component ID | | | | Component | | |
| | | | | Identifier | | |
| >>E2 Node | M | | 9.2.28 | Success or | — | |
| Component | | | | failure with | | |
| Configuration | | | | Cause | | |
| Acknowledge | | | | | | |
| E2 Retention | O | | 9.2.xx | | YES | ignore |
| Information | | | | | | |

In ‘presence’ column, the value “O” indicates ‘optional’ and a value “M” indicates ‘mandatory’.

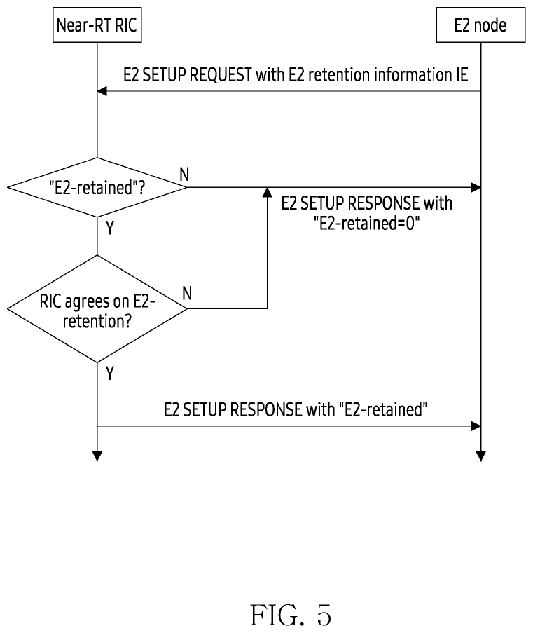

FIG. 5 illustrates an example procedure between E2 node and Near-RT RIC where “E2-retained” has been agreed between E2 nodes and Near-RT RIC.

Referring to FIG. 5, E2 node may transmit E2 SETUP REQUEST message with E2 retention information IE to a Near-RT RIC. The Near-RT RIC may receive the E2 SETUP REQUEST message from the E2 node. The E2 SETUP REQUEST message includes E2 retention information IE. The E2 retention information indicates whether (existing) E2SM related contexts and signaling connections are retained or not. E2 node may generate the E2 retention information. E2 node may include the generated E2 retention information in the E2 SETUP REQUEST message. For the E2 SETUP REQUEST message, the Table land the Table 2 may be referred.

In next step, The Near-RT RIC may obtain E2-retention information. The Near-RT RIC may obtain E2-retain information from the E2 SETUP REQUEST message. The near-RT RIC may identify whether the E2-retentinion information included in the E2 SETUP REQUEST message is set to “E2-retained” or not.

If the E2-retentinion information included in the E2 SETUP REQUEST message is set to “E2-retained”, the Near-RT RIC may perform next operations. The Near-RT RIC may determine whether to accept the E2 retention requested by E2 node or not. If the Near-RT RIC accepts the E2 retention, the Near-RT RIC may set “E2-retained” of E2 RESPONSE message to a value for indicating that E2 retention is accepted. For example, the value comprises one. The Near-RT RIC may set “E2-retained” to one. the Near-RT RIC may include the “E2-retained” in E2 RESPONSE message.

If the E2-retentinion information included in the E2 SETUP REQUEST message is not set to “E2-retained” or if the Near-RT RIC does not accept (in other words, rejects) the E2 retention, the Near-RT RIC may set “E2-retained” of E2 RESPONSE message to a value for indicating no E2 retention. For example, the value comprises zero (or ‘false’). The Near-RT RIC may set “E2-retained” to zero.

The Near-RT RIC may transmit the E2 SETUP RESPONSE message with “E2-retained” to the E2 node. The E2 node may receive the E2 SETUP RESPONSE message from the near-RT RIC. If the “E2-retaind” is set to one (or ‘true’), the E2 node may identify that the E2 retention is accepted by the near-RT Ric. Therefore, the E2 node may not perform RIC subscription procedure after E2 SETUP procedures although the SCTP connection is failed. If the “E2-retaind” is set to zero, the E2 node may identify that the E2 retention is not supported by the near-RT RIC. Therefore, the E2 node may perform RIC subscription procedure subsequent to E2 SETUP procedures after the SCTP connection is failed.

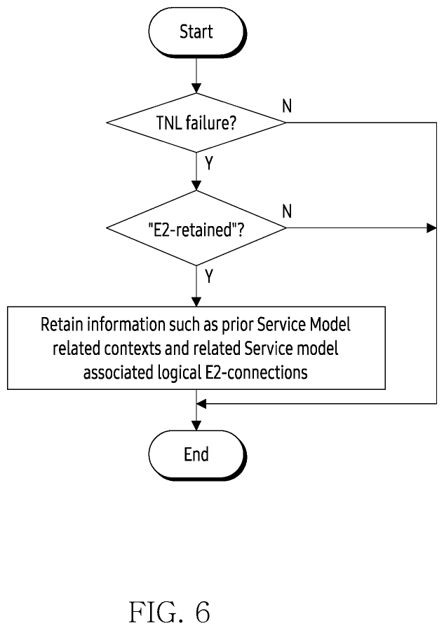

FIG. 6 illustrates an example operation at Near-RT RIC at TNL failure, when “E2-retained” has been agreed at E2 SETUP. Operations shown in FIG. 6 may be performed by Near-RT RIC.

Referring to FIG. 6, the Near-RT RIC may identify whether a TNL failure is detected or not. The TNL failure comprises a SCTP failure. The Near-RT RIC may determine whether to use E2 retention or not. In case that it does not need to restart E2SM subscriptions, the Near-RT IC may determine to not use the E2 retention. Otherwise, in case of using the E2 retention, the Near-RT RIC may retain information such as prior service model (SM) related contexts and related service model associated logical E2-connections.

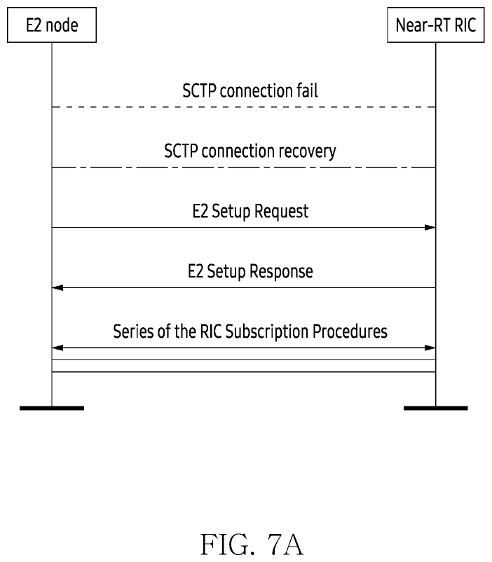

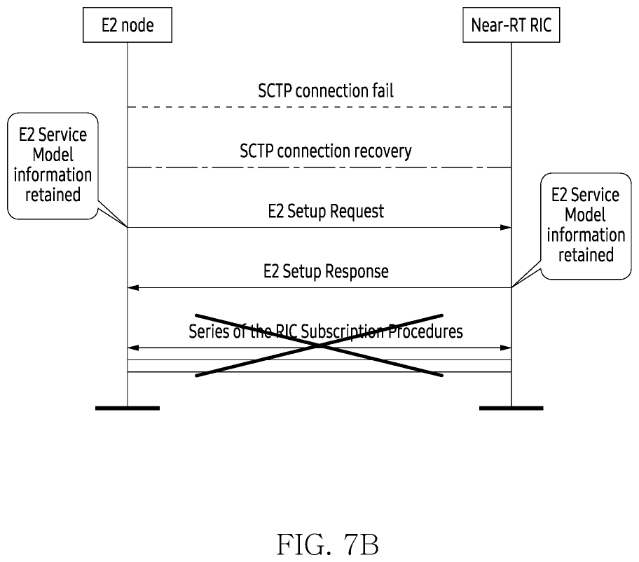

FIG. 7A illustrates procedures after the failure of the SCTP connection without E2 retention. If the SCTP connection fails, E2 Node shall restart RIC subscriptions procedures.

FIG. 7B illustrates procedures after the failure of the SCTP connection with E2 retention. With E2 retention, there is no need to restart E2SM subscriptions. Because the Near-RT RIC retains the existing E2SM related contexts and signaling connections. E2 node uses the existing E2SM related contexts and signaling connections.

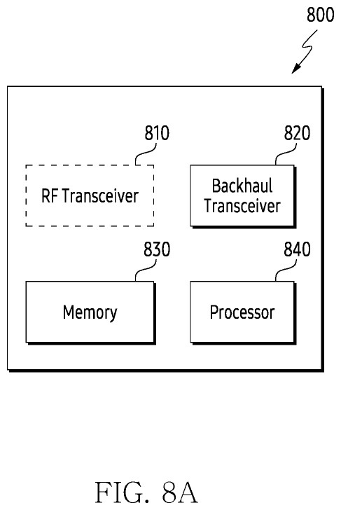

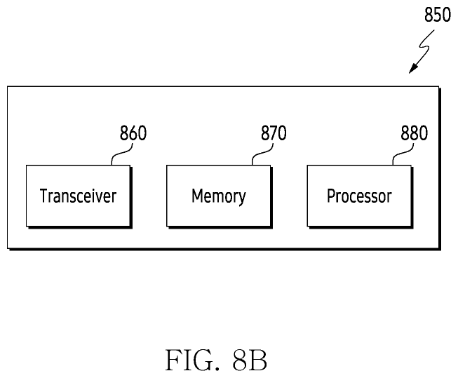

FIG. 8A illustrates exemplary components of E2 node according to embodiments. E2 node comprises a DU, CU, CU-CP, CU-UP, O-DU, O-CU, O-CU-CP, or O-CU-UP. Hereinafter, the term ‘ . . . unit’ or ‘the term’-er′ means a unit component for processing at least one function or operation, which may be implemented as hardware or software, or a combination of hardware and software.

Referring to FIG. 8A, the E2 node 800 comprises a radio frequency (RF) transceiver 810, a backhaul transceiver 820, a memory 830, and a processor 840. The RF transceiver 810 may be omitted according to the type of E2 node 800. For example, in case of the CU, CU-CP, or CU-UP, RF transceiver 810 may be omitted

The RF transceiver 810 performs operations for transmitting and receiving signals through a wireless channel. For example, the RF transceiver 810 up-converts a baseband signal into an RF band signal, transmits it through an antenna, and down-converts an RF band signal received through the antenna into a baseband signal. For example, the RF transceiver 810 may include a transmit filter, a receive filter, an amplifier, a mixer, an oscillator, a digital-to-analog converter (DAC), an analog to digital converter (ADC), and the like. The RF transceiver 810 may include one or more transmit/receive paths. Furthermore, the RF transceiver 810 may include an antenna unit. The RF transceiver 810 may include at least one antenna array composed of a plurality of antenna elements. In terms of hardware, the RF transceiver 810 may include a digital circuit and an analog circuit (e.g., a radio frequency integrated circuit (RFIC)). Here, the digital circuit and the analog circuit may be implemented as one package. Also, the RF transceiver 810 may include multiple RF chains. The RF transceiver 810 may perform beamforming. The RF transceiver 810 may apply a beamforming weight to a signal to be transmitted/received in order to provide directionality according to the setting of the processor 380 to the signal. According to an embodiment, the RF transceiver 810 may include a radio frequency (RF) block (or RF unit).

According to an embodiment, the RF transceiver 810 may transmit/receive a signal over a radio access network. For example, the RF transceiver 810 may transmit a downlink signal. The downlink signal comprises a synchronization signal (SS), a reference signal (RS) (e.g., cell-specific reference signal (CRS), demodulation (DM)-RS), system information (e.g., master information block (MIB), system information block (SIB)). The system information may include remaining system information (RMSI) or other system information (OSI). The downlink signal comprises a configuration message, control information, or downlink data. Also, for example, the RF transceiver 810 may receive an uplink signal. The uplink signal includes a random access-related signal (e.g., a random-access preamble (RAP) (or Msg1 (message 1)), Msg3 (message 3)), a reference signal (e.g., a sounding reference signal (SRS), DM). -RS), or a power headroom report (PHR), and the like. Although only the RF transceiver 810 is illustrated in FIG. 8A, according to another implementation example, the E2 node 800 may include two or more RF transceivers.

The backhaul transceiver 820 provides an interface for communicating with other nodes in the network. That is, the backhaul transceiver 820 converts a bit string transmitted from the E2 node 800 to another node, for example, another E2 node, another base station, an upper node, a core network, etc. into a physical signal, and converts the physical signal received from the other node into a bit sequence. The backhaul transceiver 820 uses a backhaul connection (e.g., wired backhaul or wireless backhaul). The backhaul transceiver 820 comprises one or more transceivers.

The memory 820 stores data such as a basic program, an application program, and setting information for the operation of the E2 node 800. The memory 820 may be configured as a volatile memory, a non-volatile memory, or a combination of a volatile memory and a non-volatile memory. In addition, the memory 820 provides the stored data according to the request of the processor 840.

The processor 840 controls overall operations of the E2 node 800. For example, the processor 840 transmits and receives signals through the RF transceiver 810. Also, the processor 840 writes and reads data in the memory 820. The processor 840 may comprises at least one processor. According to various embodiments, the processor 840 may control the device to perform operations according to various embodiments described in the present disclosure.

FIG. 8B illustrates exemplary components of Near-RT RIC according to embodiments. Hereinafter, the term ‘ . . . unit’ or ‘the term '-er’ means a unit component for processing at least one function or operation, which may be implemented as hardware or software, or a combination of hardware and software.

Referring to FIG. 8B, the Near-RT RIC 850 comprises a transceiver 860, a memory 870, and a processor 880.

The transceiver 860 provides an interface for performing communication with other devices in the network. That is, the transceiver 860 converts a bit string transmitted from the Near-RT RIC to another device into a physical signal, and converts a physical signal received from the other device into a bit string. That is, the transceiver 860 may transmit and receive signals. Accordingly, the transceiver 860 may be referred to as a modem, a transmit unit, a receive unit, or a transmit/receive unit. In this case, the transceiver 860 enables the Near-RT RIC 850 to communicate with other devices or systems through a backhaul connection (e.g., a wired backhaul or a wireless backhaul) or through a network. The communication unit 510 may include one or more transceivers.

The memory 870 stores data such as a basic program, an application program, and setting information for the operation of the Near-RT RIC 850. The memory 870 may be configured as a volatile memory, a non-volatile memory, or a combination of a volatile memory and a non-volatile memory. In addition, the memory 870 provides the stored data according to the request of the processor 880.

The processor 880 controls overall operations of the Near-RT RIC 850. For example, the processor 880 transmits and receives signals through the transceiver 860. Also, the processor 840 writes and reads data in the memory 870. The processor 880 may comprises at least one processor. According to various embodiments, the processor 880 may control the device to perform operations according to various embodiments described in the present disclosure.

According to embodiments, a method of operating a telecommunication network, comprising one or more intelligent systems in the O-RAN architecture, wherein the intelligent system retains E2 service information at TNL failure, according to information elements (IEs) via an E2 interface.

In some embodiments, the IE comprises E2 retention IEs in an E2 SETUP message via the E2 interface.

In some embodiments, the IE comprises “E2-retained” indication, requested by the E2 nodes via the E2 interface, by including the E2 Retention Information IE set to “E2-retained” in an E2 SETUP REQUEST message.

In some embodiments, “E2-retained” indication in the aforementioned UE retention IE, accepted by Near-RT RIC via the E2 interface, by including the E2 Retention Information IE set to “E2-retained” in the E2 SETUP RESPONSE message is used.

In some embodiments, the Near-RT RIC retains the existing E2SM related contexts and signaling connections at TNL failure, when “E2-retained” is enabled.

In some embodiments, the protocol between E2 nodes and Near-RT RIC in agreeing on retaining E2 service information at E2 SETUP is used.

In some embodiments, the intelligent system makes a decision of whether to retain E2 service information, according to the settings of the aforementioned IE (E2 Retention IE) and indicator (“E2-retained”).

According to various embodiments, a method performed by a E2 node, the method comprises transmitting, to a near-real time (Near-RT) radio access network (RAN) intelligent controller (RIC) via an E2 interface, a E2 setup request message including E2 retention information. The method comprises receiving, from the Near-RT RIC via the E2 interface, a E2 setup response message in response to the E2 setup request message including E2 retention indication.

In some embodiments, the E2 retention information is used to request E2 retention for E2 service model (SM) related contexts and signaling connections. The E2 retention indication is used to indicate whether the E2 retention is accepted in the Near-RT RIC or not.

In some embodiments, the E2 setup request message including the E2 retention information is transmitted in case that a failure of a transport network layer (TNL) is detected. The TNL comprises a stream control transmission protocol (SCTP) layer.

In some embodiments, the method comprises, based on identifying that the E2 retention indication indicates a first value, using E2 service information obtained a RIC subscription procedure before transmitting the E2 setup request message. The method comprises based on identifying that the E2 retention indication indicates a second value different from the first value, performing a RIC subscription procedure with the E2 node.

In some embodiments, the E2 setup request message further includes a message type information element (IE), a transaction identifier (ID) IE, an ID of the E2 node, RAN function added list IE, and E2 node component configuration addition list IE.

In some embodiments, the E2 setup response message further comprises a message type information element (IE), a transaction identifier (ID) IE, an ID of the Near-RT RIC, and E2 node component configuration acknowledge list IE, and the E2 setup response message further includes RAN function accepted list IE or RAN function rejected list IE.

In some embodiments, the E2 setup response message may not include the E2 retention indication, to notify the E2 node of a result of E2 retention. For example, the result of E2 retention indicates ‘accept’ or ‘reject’.

According to various embodiments, a method performed by a near-real time (Near-RT) radio access network (RAN) intelligent controller (RIC). The method comprises receiving, from a E2 node via an E2 interface, a E2 setup request message including E2 retention information. The method comprises transmitting, to the E2 node via the E2 interface, a E2 setup response message in response to the E2 setup request message including E2 retention indication.

In some embodiments, the E2 retention information is used to request E2 retention for E2 service model (SM) related contexts and signaling connections. The E2 retention indication is used to indicate whether the E2 retention is accepted in the Near-RT RIC or not.

In some embodiments, the E2 setup request message including the E2 retention information is transmitted in case that a failure of a transport network layer (TNL) is detected. The TNL comprises a stream control transmission protocol (SCTP) layer.

In some embodiments, the method comprises, based on identifying that the E2 retention indication indicates a first value, performing a RIC subscription procedure with the E2 Near-RT RIC. The method comprises, based on identifying that the E2 retention indication indicates a second value different from the first value, not performing the RIC subscription procedure with the E2 Near-RT RIC.

In some embodiments, the E2 setup request message further includes a message type information element (IE), a transaction identifier (ID) IE, an ID of the E2 node, RAN function added list IE, and E2 node component configuration addition list IE.

In some embodiments, the E2 setup response message further comprises a message type information element (IE), a transaction identifier (ID) IE, an ID of the Near-RT RIC, and E2 node component configuration acknowledge list IE. The E2 setup response message further includes RAN function accepted list IE or RAN function rejected list IE.

In some embodiments, the E2 setup response message may not include the E2 retention indication, to notify the E2 node of a result of E2 retention. For example, the result of E2 retention indicates ‘accept’ or ‘reject’.

According to various embodiments, E2 node comprises at least one transceiver and at least one processor operably coupled to the at least one transceiver. The at least one processor is configured to control the at least one transceiver to transmit, to a near-real time (Near-RT) radio access network (RAN) intelligent controller (RIC) via an E2 interface, a E2 setup request message including E2 retention information. The at least one processor is configured to control the at least one transceiver to receive, from the Near-RT RIC via the E2 interface, a E2 setup response message in response to the E2 setup request message including E2 retention indication.

According to various embodiments, a near-real time (Near-RT) radio access network (RAN) intelligent controller (RIC), comprises at least one transceiver; and at least one processor operably coupled to the at least one transceiver. The at least one processor is configured to control the at least one transceiver to receive, from a E2 node via an E2 interface, a E2 setup request message including E2 retention information. The at least one processor is configured to control the at least one transceiver to transmit, to the E2 node via the E2 interface, a E2 setup response message in response to the E2 setup request message including E2 retention indication.

According to various embodiments, E2 node comprises at least one transceiver and at least one processor operably coupled to the at least one transceiver. The at least one processor is configured to control the at least one transceiver to transmit, to a near-real time (Near-RT) radio access network (RAN) intelligent controller (RIC) via an E2 interface, a E2 setup request message including E2 retention information. The at least one processor is configured to control the at least one transceiver to receive, from the Near-RT RIC via the E2 interface, a E2 setup response message in response to the E2 setup request message including E2 retention indication.

According to various embodiments, a near-real time (Near-RT) radio access network (RAN) intelligent controller (RIC), comprises at least one transceiver; and at least one processor operably coupled to the at least one transceiver. The at least one processor is configured to control the at least one transceiver to receive, from a E2 node via an E2 interface, a E2 setup request message including E2 retention information. The at least one processor is configured to control the at least one transceiver to transmit, to the E2 node via the E2 interface, a E2 setup response message in response to the E2 setup request message including E2 retention indication.

Throughout this specification, the term “comprising” or “comprises” means including the component(s) specified but not to the exclusion of the presence of other components. The term “consisting essentially of” or “consists essentially of” means including the components specified but excluding other components except for materials present as impurities, unavoidable materials present as a result of processes used to provide the components, and components added for a purpose other than achieving the technical effect of the invention, such as colourants, and the like.

The term “consisting of” or “consists of” means including the components specified but excluding other components.

Whenever appropriate, depending upon the context, the use of the term “comprises” or “comprising” may also be taken to include the meaning “consists essentially of” or “consisting essentially of”, and also may also be taken to include the meaning “consists of” or “consisting of”.

The optional features set out herein may be used either individually or in combination with each other where appropriate and particularly in the combinations as set out in the accompanying claims. The optional features for each aspect or exemplary embodiment of the invention, as set out herein are also applicable to all other aspects or exemplary embodiments of the invention, where appropriate. In other words, the skilled person reading this specification should consider the optional features for each aspect or exemplary embodiment of the invention as interchangeable and combinable between different aspects and exemplary embodiments.

### REFERENCES

[1] O-RAN.WG3.E2SM-RC-v01.00.03
[2] O-RAN.WG3.E2AP-v01.01
[3] O-RAN Architecture Description v4.0
[4] 3GPP TR 36.902 V9.3.1 (2011-03) ‘E-UTRAN; Self-configuring and self-optimizing network (SON) use cases and solutions’
[5] TS 38.413, NG Application Protocol, NGAP

Although a preferred embodiment has been shown and described, it will be appreciated by those skilled in the art that various changes and modifications might be made without departing from the scope of the invention, as defined in the appended claims and as described above.

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a Field Programmable Gate Array (FPGA) or Application Specific Integrated Circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

What is claimed is:

1. A method performed by an E2 node, the method comprising:
transmitting, to a near-real time (Near-RT) radio access network (RAN) intelligent controller (RIC) via an E2 interface, a E2 setup request message including E2 retention information; and
receiving, from the Near-RT RIC via the E2 interface, a E2 setup response message in response to the E2 setup request message including E2 retention indication.

2. The method of claim 1,
wherein the E2 retention information is used to request E2 retention for E2 service model (SM) related contexts and signaling connections, and
wherein the E2 retention indication is used to indicate whether the E2 retention is accepted in the Near-RT RIC or not.

3. The method of claim 1,
wherein the E2 setup request message including the E2 retention information is transmitted in case that a failure of a transport network layer (TNL) is detected, and
wherein the TNL comprises a stream control transmission protocol (SCTP) layer.

4. The method of claim 1, further comprising:
based on identifying that the E2 retention indication indicates a first value, using E2 service information obtained a RIC subscription procedure before transmitting the E2 setup request message; and
based on identifying that the E2 retention indication indicates a second value different from the first value, performing a RIC subscription procedure with the E2 node.

5. The method of claim 1, wherein the E2 setup request message further includes a message type information element (IE), a transaction identifier (ID) IE, an ID of the E2 node, RAN function added list IE, and an E2 node component configuration addition list IE.

6. The method of claim 1, wherein the E2 setup response message further comprises a message type information element (IE), a transaction identifier (ID) IE, an ID of the Near-RT RIC, and an E2 node component configuration acknowledge list IE, and
wherein the E2 setup response message further includes RAN function accepted list IE or RAN function rejected list IE.

7. A method performed by a near-real time (Near-RT) radio access network (RAN) intelligent controller (RIC), the method comprising:
receiving, from an E2 node via an E2 interface, a E2 setup request message including E2 retention information; and
transmitting, to the E2 node via the E2 interface, a E2 setup response message in response to the E2 setup request message including E2 retention indication.

8. The method of claim 7,
wherein the E2 retention information is used to request E2 retention for E2 service model (SM) related contexts and signaling connections, and
wherein the E2 retention indication is used to indicate whether the E2 retention is accepted in the Near-RT RIC or not.

9. The method of claim 7,
wherein the E2 setup request message including the E2 retention information is transmitted in case that a failure of a transport network layer (TNL) is detected, and
wherein the TNL comprises a stream control transmission protocol (SCTP) layer.

10. The method of claim 7, further comprising:
based on identifying that the E2 retention indication indicates a first value, performing a RIC subscription procedure with the E2 Near-RT RIC; and
based on identifying that the E2 retention indication indicates a second value different from the first value, not performing the RIC subscription procedure with the E2 Near-RT RIC.

11. The method of claim 7, wherein the E2 setup request message further includes a message type information element (IE), a transaction identifier (ID) IE, an ID of the E2 node, RAN function added list IE, and an E2 node component configuration addition list IE.

12. The method of claim 7, wherein the E2 setup response message further comprises a message type information element (IE), a transaction identifier (ID) IE, an ID of the Near-RT RIC, and an E2 node component configuration acknowledge list IE, and
wherein the E2 setup response message further includes RAN function accepted list IE or RAN function rejected list IE.

13. An E2 node comprising:
at least one transceiver; and
at least one processor, operably coupled to the at least one transceiver, configured to:
control the at least one transceiver to transmit, to a near-real time (Near-RT) radio access network (RAN) intelligent controller (RIC) via an E2 interface, a E2 setup request message including E2 retention information; and
control the at least one transceiver to receive, from the Near-RT RIC via the E2 interface, a E2 setup response message in response to the E2 setup request message including E2 retention indication.

14. A near-real time (Near-RT) radio access network (RAN) intelligent controller (RIC), comprising:
at least one transceiver; and
at least one processor, operably coupled to the at least one transceiver, configured to:
control the at least one transceiver to receive, from an E2 node via an E2 interface, a E2 setup request message including E2 retention information; and
control the at least one transceiver to transmit, to the E2 node via the E2 interface, a E2 setup response message in response to the E2 setup request message including E2 retention indication.
